(19) United States
(12) Patent Application Publication
(10) Pub. No.: US 2009/0218785 A1
(43) Pub. Date: Sep. 3, 2009

(54) Bicycle wire supporting frame

(76) Inventors: Wen-Feng Tsai, Taichung (TW); Tom Berlivet, Taichung (TW)

Correspondence Address: Chien-Hui Su, P. O. Box 70-121 Taichung, Taichung City, 40899, TW

(21) Appl. No.: 11/481,681

(22) Filed: Jul. 7, 2006

(51) Int. Cl. B62K 21/00

(52) U.S. Cl. 280/279

(57) ABSTRACT

A bicycle wire supporting frame includes a ring cover capable of being assembled to a head rod of a bicycle; the ring cover having an axial through hole for receiving the head rod; an extension portion extended from one end of the ring cover; and a wire hole penetrating through the extension portion along an axial direction. An upper opening of the through hole is connected to an inclined ring for receiving a receiving lower edge of a C ring so that the head rod is tightly engaged to the through hole of the ring cover. An inner side of the through hole is formed with an inclined surface so as to receive an inclined surface of the tapered ring so that the head rod is tightly engaged to the through hole of the ring cover. A slit penetrates through the extension portion.

### FIELD OF THE INVENTION

The present invention relates to bicycles, and in particular to a bicycle wire supporting frame, wherein the prior art bicycle bowl structure is improved so that the wires can be tightly engaged to a ring cover without falling out or inclination.

### BACKGROUND OF THE INVENTION

Bicycles have become popular exercise devices in daily life. More and more people drive bicycles as exercise and in life. However the prior art designs of bicycles have complicated structures. In the design, the head portion of the bicycle is very important for the stability of the bicycle.

In the prior art design, the upper cover and wires are not firmly secured so that the wires easily fall out or tilt from the upper cover. Thereby the drive will feel uneasy and thus the interest in outdoor exercise is reduced. In one prior art, a C ring is used. An extension sheet is extended from the C ring and a wire ring is installed at one end of the extension sheet. The transversal position of the extension sheet is formed with a long through hole and a receiving hole at a middle portion thereof. The through hole is communicated to the receiving hole. The long through hole is divided into two sections at a middle section thereof. One is a small through hole with female threads and another one is a larger through hole. The extension sheet has a tighten block which can be placed in the larger through hole. The tighten block has a via hole and a front end thereof has a very small half cambered projection. A stud passes through the via hole. The head of the stud presses the tightening block to move forwards so that a recess of the tightening block has a middle portion which is placed at a tube wall of a stand tube so as to be fixed to the stand tube.

However in this prior art although the tightening block is used, but the wire supporting frame is still positioned from a lateral side. The function of the frame is different from a head bowl like structure. The frame will interfere the bowl like structure. For a long time, the bowl like structure will inclines. As a whole, the prior art structure is not practical and is necessary to be improved.

### SUMMARY OF THE INVENTION

Accordingly, the primary object of the present invention is to provide a bicycle wire supporting frame, wherein the prior art bicycle bowl structure is improved so that the wires can be tightly engaged to a ring cover without falling out or inclination.

To achieve above objects, the present invention provides a bicycle wire supporting frame, comprises an ring cover capable of being assembled to a head rod of a bicycle; the ring cover having an axial through hole for receiving the head rod; an extension portion extended from one end of the ring cover; a wire hole penetrating through the extension portion along an axial direction. An upper opening of the through hole is connected to an inclined ring for receiving a receiving lower edge of the C ring so that the head rod is tightly engaged to the through hole of the ring cover. An inner side of the through hole is formed with an inclined surface so as to receive the inclined surface of the tapered ring so that the head rod is tightly engaged to the through hole of the ring cover. A slit penetrates through the extension portion so that the wire hole is communicated to exterior through the slit so that wires of the bicycle can pass through the slit to enter into the wire hole.

The various objects and advantages of the present invention will be more readily understood from the following detailed description when read in conjunction with the appended drawing.

### BRIEF DESCRIPTION OF THE DRAWINGS

FIG. 1 is an exploded perspective view of the bicycle wire supporting frame of the present invention.

FIG. 2 is a partial schematic view of the bicycle wire supporting frame of the present invention.

FIG. 3 is an assembled cross sectional view of the bicycle wire supporting frame of the present invention.

FIG. 4 is a schematic view about the second embodiment of the present invention.

FIG. 5 is a cross sectional view of the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

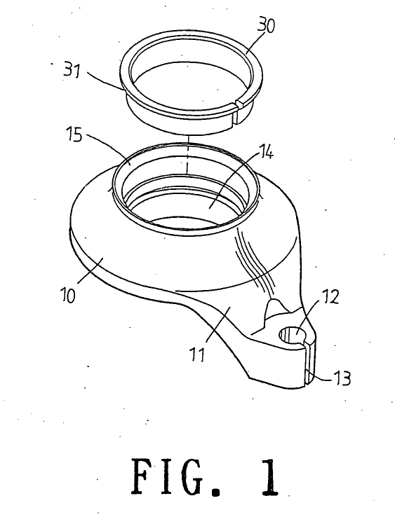

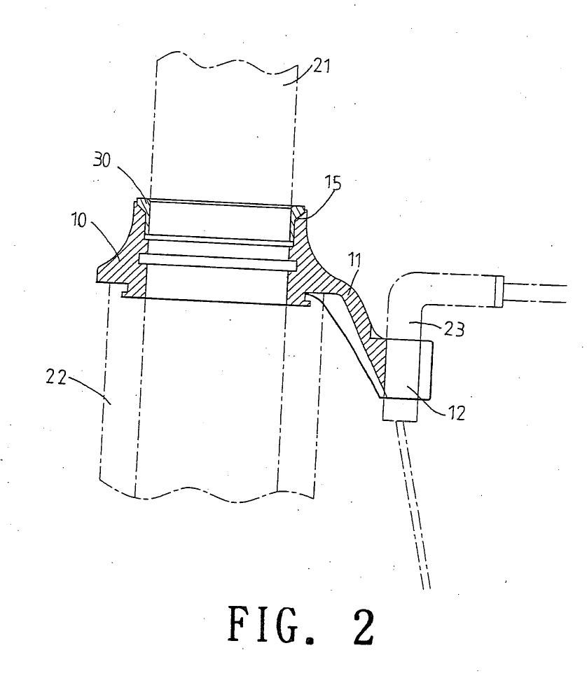

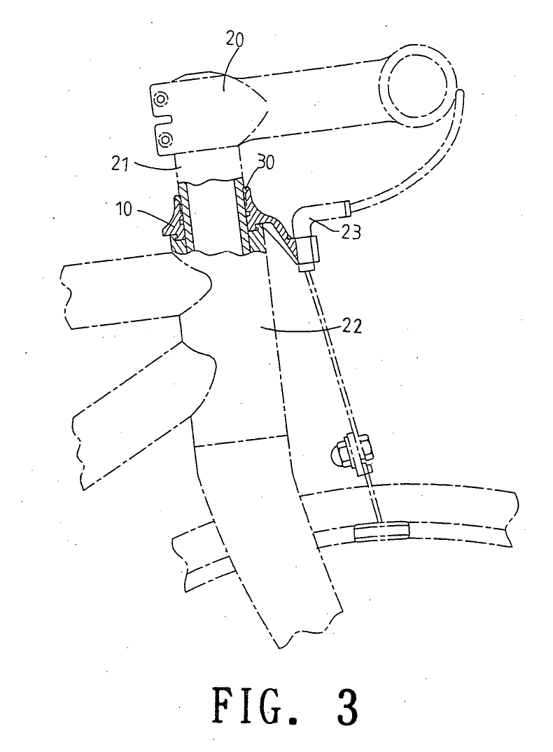

With reference to FIGS. 1 to 5, the bicycle wire supporting frame of the present invention is illustrated. The present invention has the following elements.

An integral formed ring cover 10 is assembled to a head rod 21 of a bicycle. The ring cover 10 has the function the upper cover of a bicycle front bowl structure. A C ring 30 or a tapered ring 40 can be used to tighten the head rod 21 and the ring cover 10. The ring cover 10 has an axial through hole 14 for receiving the head rod 21. The C ring 30 or the tapered ring 40 serves to lock the ring cover 10 to the head rod 21. Thus wires can be retained firmly without movement due to collision.

An extension portion 11 extends from one end of the ring cover 10. A wire hole 12 penetrates through the extension portion 11 along an axial direction. A slit 13 penetrates through the extension portion 11 so that the wire hole 12 is communicated to exterior through the slit 13. The extension portion 11 is used as a wire supporting frame so that wires of the bicycle can pass through the slit 13 to enter into the wire hole 12.

Referring to FIGS. 1 to 3, the application of the present invention is illustrated. An upper opening of the through hole 14 is connected to an inclined ring 15 for receiving a receiving lower edge 31 of the C ring 30 so that the head rod 21 is tightly engaged to the through hole 14 of the ring cover 10.

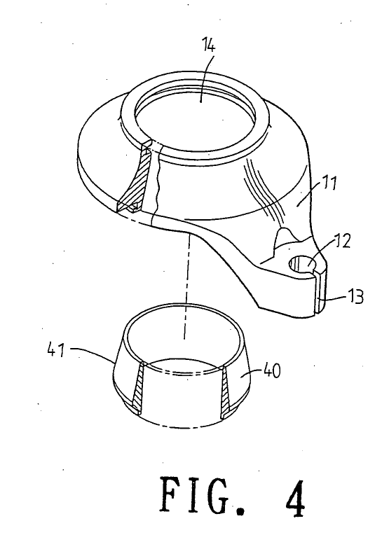

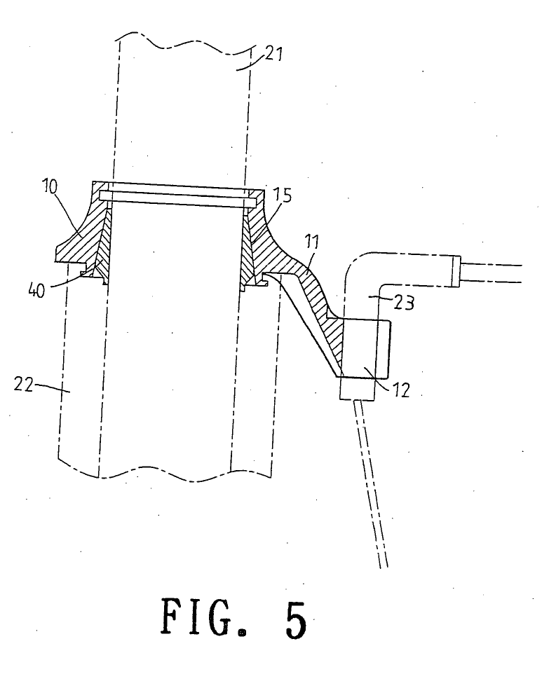

Referring to FIGS. 4 and 5, another application of the present invention is illustrated. The inner side of the through hole 14 is formed with an inclined surface 15 so as to receive the inclined surface 41 of the tapered ring 40 so that the head rod 21 is tightly engaged to the through hole 14 of the ring cover 10.

However in the present invention, both the inclined inner surface and the inclined ring can be installed to the ring cover 10 of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. (canceled)

2. A bicycle wire supporting frame, comprising:
a ring cover capable of being assembled to a head rod of a bicycle; the ring cover having an axial through hole for receiving the head rod; wherein an upper side of the ring cover is an tapered surface;
an extension portion extended from one end of the ring cover; a wire hole penetrating through the extension portion along an axial direction; and
wherein an upper opening of the through hole is connected to an inclined ring for receiving a receiving lower edge of a C ring so that the head rod is tightly engaged to the through hole of the ring cover; wherein an upper edge is protruded from an upper outer side of the C ring so as to resist against the inclined ring for retaining the C ring to the inclined ring.

3. A bicycle wire supporting frame, comprising:
a ring cover capable of being assembled to a head rod of a bicycle; the ring cover having an axial through hole for receiving the head rod; wherein an upper side of the ring cover is an tapered surface;
an extension portion extended from one end of the ring cover; a wire hole penetrating through the extension portion along an axial direction; and
wherein an inner side of the through hole is formed with an inclined surface so as to receive an inclined surface of a tapered ring and thus the head rod is tightly engaged to the through hole of the ring cover.

4. The bicycle wire supporting frame as claimed in claim 1, wherein a slit penetrates through the extension portion so that the wire hole is communicated to exterior through the slit and thus wires of the bicycle can pass through the slit to enter into the wire hole.
